(19) United States
(12) Patent Application Publication
(10) Pub. No.: US 2019/0349829 A1
(43) Pub. Date: Nov. 14, 2019

(54) SYSTEM AND METHOD FOR SWITCHING A COMMUNICATION CHANNEL FROM A DATA NETWORK TO A CELLULAR NETWORK DURING OBSERVED AUDIO/VIDEO QUALITY DEGRADATION

(71) Applicant: Avaya Inc., Santa Clara, CA (US)

(72) Inventors: Mehmet Balasaygun, Freehold, NJ (US); Kurt Haserodt, Westminster, CO (US)

(21) Appl. No.: 15/973,841

(22) Filed: May 8, 2018

(51) Int. Cl. H04W 36/30; H04W 36/36; H04W 76/19; H04L 29/08; H04W 76/30; H04L 29/06

(52) U.S. Cl. CPC H04W 36/30; H04W 36/365; H04W 76/19; H04M 3/44; H04W 76/30; H04L 65/1069; H04L 67/18; H04L 67/26

(57) ABSTRACT

A mobile device joins a communication session using a data communication channel. A determination is made the data communication channel uses a data network of the mobile device. A determination is made that, during the communication session, a quality of the data communication channel has decreased. In response to determining that the data communication channel uses the data network of the mobile device and determining that the quality of the data communication channel has decreased, a push notification message is sent to a push notification service. The push notification message comprises a cellular network dial-able number that is used by a cellular application in the mobile device to initiate a call to join the communication session via a cellular communication channel that uses a cellular network.

### FIELD

The disclosure relates generally to quality of service management and particularly to quality of service management of active communication sessions.

### BACKGROUND

Today, when a call is made using Voice over Internet Protocol (VoIP) from a mobile device, the network (a data network in this case) that is used does not change during the call. The problem is that as the mobile device moves across different coverage areas, the characteristics of mobile data network can change and become unreliable at times. This can cause the VoIP media quality (e.g., voice and/or video) to degrade and even cause a loss of connection. The user has no other reliable options than to deal with the lower quality communion session.

### SUMMARY

These and other needs are addressed by the various embodiments and configurations of the present disclosure. A mobile device joins a communication session using a data communication channel. A determination is made the data communication channel uses a data network of the mobile device. A determination is made that, during the communication session, a quality of the data communication channel has decreased. In response to determining that the data communication channel uses the data network of the mobile device and determining that the quality of the data communication channel has decreased, a push notification message is sent by the communication server to a push notification service. The push notification message comprises a cellular network dial-able number that is used by a cellular phone application in the mobile device to initiate a call to join the communication session via a cellular communication channel that uses a cellular network.

In another embodiment, the mobile device joins a communication session using a data communication channel. A determination is made that the data communication channel uses a data network of the mobile device. A determination is made that, during the communication session, a quality of the data communication channel has decreased. In response to determining the data communication channel uses the data network and determining that the quality of the data channel has decreased, a call is initiated to or from the mobile device, via a cellular communication channel.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

The term “cellular network” as defined herein is where voice, video, and/or virtual reality calls are made using the built-in cellular application in the cell phone to access a carrier's cellular network. For cellular telephones, the user typically has access to the cellular network (e.g., for voice/video calls) and access to a data network (for Internet Access). For example, a user may go to AT&T® and purchase a cell phone that has unlimited voice calls and a limit of ten Gigs of Internet access each month. As described herein, the term “cellular network” does not include the data network that is used by the cellular telephone to access the Internet and/or data services.

As described herein, the terms “call” and “communication session” may be used interchangeably. For example, a conference call means the same thing as a conference session.

The term “conference session” is any communication session where two or more user are connected and communication using voice, video, or virtual reality communications. As described herein, a conference session is a form of communication session.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for switching a data communication channel to a cellular communication channel based on an observed audio/video quality degradation.

FIG. 2 is a flow diagram of a process for switching a data communication channel to a cellular communication channel based on an observed audio/video quality degradation.

FIG. 3 is a flow diagram of a process for reestablishing a data communication channel.

FIG. 4 is a flow diagram of a process for switching a data communication channel to a cellular communication channel based on an observed audio/video quality degradation.

FIG. 5 is a diagram of a display on a mobile device for switching from a data communication channel to a cellular communication channel based on an observed audio/video quality degradation.

### DETAILED DESCRIPTION

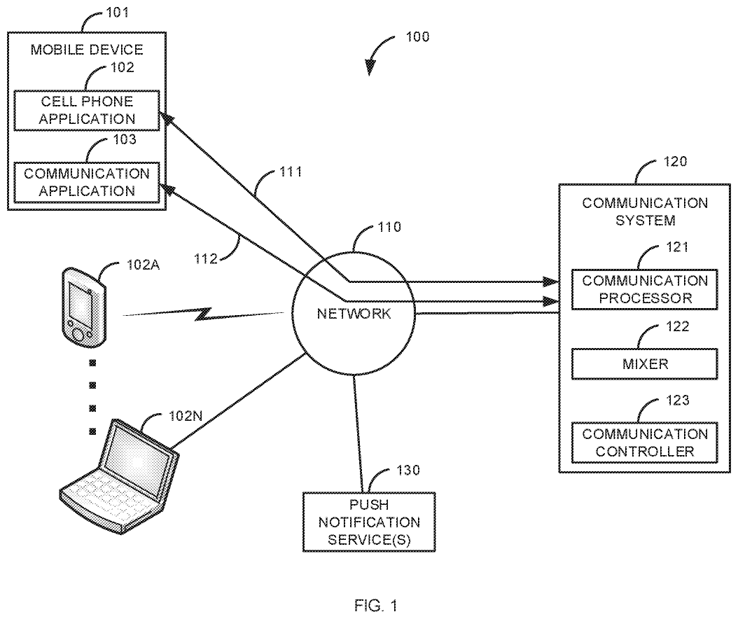

FIG. 1 is a block diagram of a first illustrative system 100 for switching a data communication channel 112 to a cellular communication channel 111 based on an observed audio/video quality degradation. The first illustrative system 100 comprises a mobile device 101, communication endpoints 102A-102N, a network 110, a communication system 120, and push notification service(s) 130.

The mobile device 101 can be or may include any mobile device 101 that can communicate on a cellular network (e.g., network 110), such as, a cellular telephone, a Personal Digital Assistant (PDA), a tablet device, a laptop device, a notebook device, a smartphone, and/or the like. Although not shown, there may be other mobile devices 101 connected to the network 110 that may use the processes described herein.

The mobile device 101 further comprises a cellphone application 102 and a communication application 103. Although not shown, the mobile device 101 may comprise other applications, such as a browser.

The cell phone application 102 can be or may include any cell phone application 102 that can establish a voice, a video, and/or a virtual reality communication session using a cellular network 110. The cell phone application 102 is typically pre-installed (built-in) on the mobile device 101 before a user purchases the mobile device 101.

The communication application 103 can be or may include any communication application 103 that can be loaded or installed onto the mobile device 101. The communication application 103 communicates with the communication controller 123 to provide the ability to switch a communication session to a different communication channel. In one embodiment, the communication application 103 may be a web based communication application 103 that runs in a browser (not shown).

The communication endpoints 102A-102N can be or may include any communication endpoint device that can communicate on the network 110, such as a Personal Computer (PC), a telephone, the mobile device 101, a video phone, a desktop computer, and/or the like. The communication endpoints 102A-102N are devices where a communication session ends. The communication endpoints 102A-102N are not network elements that facilitate and/or control communication sessions in the network 110, such as a communication manager or router. As shown in FIG. 1, any number of communication endpoints 102A-102N may be connected to the network 110.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, multiple cellular networks, a combination of these, and the like. The network 110 can use a variety of electronic protocols, such as Ethernet, Internet Protocol (IP), Session Initiation Protocol (SIP), Integrated Services Digital Network (ISDN), Global System for Mobile Communications (GSM), General Packet Radio Service (GPRS), Interim Standard (IS-95), MIT Multi-Carrier IMT-MC, Enhanced GSM, Universal Mobile Telecommunications System (UMTS), and/or the like. Thus, the network 110 is an electronic communication network configured to carry messages (e.g., voice, video, data) via packets and/or circuit switched communications.

In FIG. 1, the mobile device 101 communicates with the communication system 120 in different ways. For example, the cell phone application 102 uses a cellular communication channel 111 that includes a cellular network (part of the network 110) that works with the mobile device 101. The mobile device 101 may initially make a call using a cellular network via the cell phone application 102. The call is then routed to the communication system 120 where it is connected with the communication controller 123/communication endpoints 102A-102N. A cellular communication channel 111, does not necessarily have to only use the cellular network. For example, the cell phone application 102 may initiate a call via the cellular network that is then routed to the communication system 120 using the Public Switched Telephone Network (PSTN). In this example, the cellular network is only one element of the network 110.

The mobile device 101 may also communicate with the communication system 120 (using communication application 103) using a data communication channel 112 (e.g., the Internet (part of network 110)). For example, a user may initiate a Voice over Internet Protocol (VoIP) call to the communication system 120 using the data communication channel 112.

The cellular communication channel 111 and the data communication channel 112 each use a different network path for communication sessions that are routed to the communication system 120. In FIG. 1, the communication endpoints 102A-102N may use the cellular communication channel 111 and/or the data communication channel 112. The communication endpoints 102A-102N may use the same cellular communication channel 111 and/or the same data communication channel 112 as the mobile device 101 and/or a different cellular communication channel 111/data channel 112.

The communication system 120 can be or may include any hardware coupled with software that can manage a communication session. For example, communication system 120 may be a Private Branch Exchange (PBX), a switch, a proxy server, a router, a conferencing system, a conference bridge, and/or the like. The communication session may be an audio communication session, a video communication session, a multimedia communication session, a virtual reality communication session, and/or the like. A communication session may comprise two or more mobile devices 101 and/or communication endpoints 102A-102N.

A virtual reality conference is where an avatar is displayed on behalf of the user to other users in the conference session. The Avatar may be able to be moved by the user to talk with other users in a virtual reality setting.

The communication system 120 further comprises a communication processor 121, a mixer 122, and a communication controller 123. The communication processor 121 can be or may include any hardware coupled with software that can manage connection of mobile devices 101/communication endpoints 102A-102N to a communication/conference session, such as a Private Branch Exchange (PBX), a session manager, a router, a switch, and/or the like. The communication processor 121 may receive and/or initiate requests for a communication/conference session.

The mixer 122 can be or may include any hardware coupled with software that can mix signals for a conference session. The mixer 122 may mix audio, video, multimedia, virtual reality signals and/or the like for the conference session. The mixer 122 may mix signals from the mobile device(s) 101/communication endpoint(s) 102A-102N that communicate using different types of communication media. For example, the mobile device 101 may communicate using only audio while the communication endpoints 102A-102N may communicate using video (with audio) or virtual reality (with audio) in the conference session. The mixer 122 may mix voice/video/virtual reality for multiple concurrent conference sessions.

The communication controller 123 can be or may include any hardware coupled with software that can manage a communication and/or conference session, such as an Avaya Equinox™ system, an Avaya Aura® Conferencing system, an Avaya Aura® system, and/or the like. The communication controller 123 can determine quality of communication links for individual mobile devices 101 calling into the communication controller 123. The communication controller 123 may manage conferencing services, such as passcode authentication, user authentication, and/or the like. The communication controller 123 may provide other services, such as, an Interactive Voice Response (IVR) system, a whisper system (e.g., where messages are presented audibly in a communication session), and/or the like.

The push notification service(s) 130 can be any known or envisioned push notification service 130, such as, Apple® Push Notification service 130, Google® Firebase Push Notification service 130, and/or the like. The push notification service(s) 130 allows for messages to be sent to applications (e.g., the communication application 103) on the mobile device 101, which cause the applications to be activated and/or respond in response to receiving a message from the push notification service 130. In one embodiment, the communication system 120 may use multiple push notification services 130. For example, one mobile device 101 may use the Apple® Push Notification service 130 (e.g., an iPhone®) and another mobile device 101 may use the Google® Firebase Push Notification service 130 (e.g., an Android® phone).

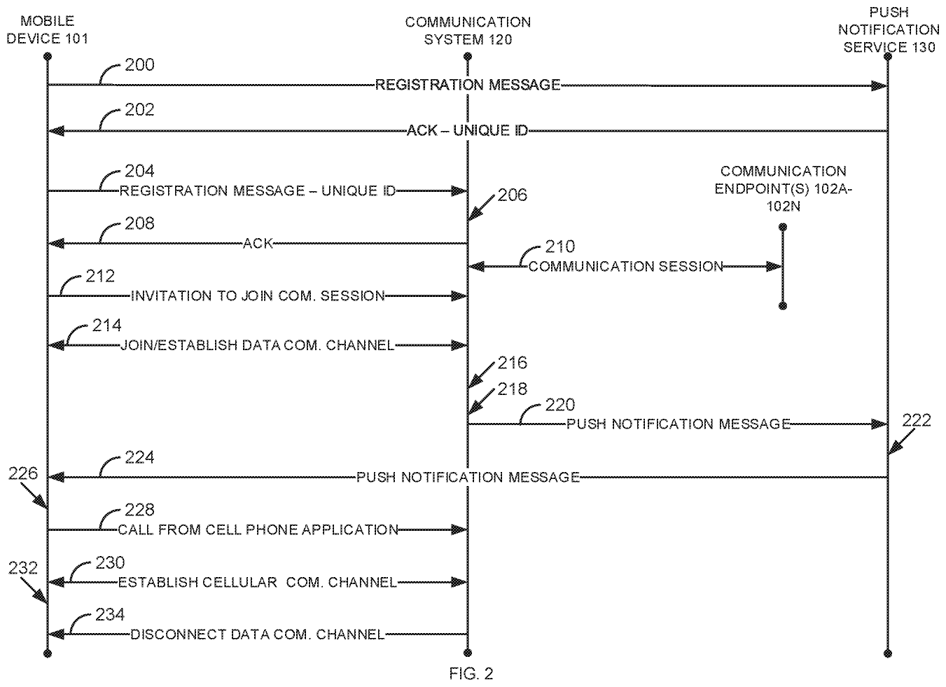

FIG. 2 is a flow diagram of a process for switching a data communication channel 112 to a cellular communication channel 111 based on an observed audio/video quality degradation. Illustratively, the mobile device 101, the cell phone application 102, the communication application 103, the communication endpoints 102A-102N, the network 110, the communication system 120, the communication processor 121, the mixer 122, communication controller 123, and the push notification service(s) 130 are stored-program-controlled entities, such as a computer or microprocessor, which performs the method of FIGS. 2-4 and the processes described herein by executing program instructions stored in a computer readable storage medium, such as a memory (i.e., a computer memory, a hard disk, and/or the like). Although the methods described in FIGS. 2-4 are shown in a specific order, one of skill in the art would recognize that some or all of the steps in FIGS. 2-4 may be implemented in different orders and/or be implemented in a multi-threaded environment. Moreover, various steps may be omitted or added based on implementation.

The process starts, in step 200, where the mobile device 101 (the communication application 103) sends a registration message to the push notification service 130. The registration message of step 200 may be sent at various times. For example, the registration message of step 200 may be sent as part of an installation process for the communication application 103. Alternatively, the registration message of step 200 may be sent sometime after the communication application 103 is installed. For instance, when the communication application 103 is first brought up by a user. The registration message of step 200 is sent to register the communication application 103 with the push notification service 130. For example, the registration message of step 200 may be sent to an Apple® Push Notification service 130 where the mobile device 101 is an iPhone®.

In response to receiving the registration message of step 200, the push notification service 130 sends an acknowledgement message, in step 202, to the communication application 103. The acknowledgement message of step 202 includes a unique identifier. The unique identifier of step 202 uniquely identifies the communication application 103 in the mobile device 101 from other applications and from the same communication application 103 on another mobile device 101. For example, the unique identifier sent in step 202 will be different for the same communication application 103 that is running on another mobile device 101.

In response to receiving the unique identifier, the communication application 103 sends, in step 204, a registration message to the communication system 120 (the communication controller 123 in this example). The registration message of step 204 includes the unique identifier received in step 202. In addition, the registration message of step 204 may include other information, such as, a cellular telephone number of the mobile device 101, a data network telephone number/address, an identifier for the communication application 103 (used to identify a data network call), a user name, a caller Identifier (caller ID), a hardware identifier of the mobile device 101, other user/device information, and/or the like. The communication controller 123 stores, in step 206, the information received in step 204 (i.e., the unique identifier, the cellular telephone number, etc.). The communication controller 123 associates the unique identifier with the other received information (i.e., the cellular telephone number). In response to receiving the registration message of step 204, the communication system 120 (the communication controller 123) sends an acknowledgement message, in step 208, to the communication application 103 in the mobile device 101.

In one embodiment, where the communication controller 123 is a conference manager (e.g., a conference bridge), a conference session may already be established with the communication endpoints 102A-102N as shown in step 210. For example, the communication endpoints 102A-102N may have already called into the conference bridge prior to the mobile device 101 calling into the conference bridge. Alternatively, the communication session of step 210 may be established after or during steps 212-214.

The mobile device 101 (via the communication application 103) sends, in step 212, an invitation to join a communication session using a data communication channel 112 (e.g., via the Internet). As discussed herein, join may also include establishing the communication/conference session with a communication endpoint 102. The invitation of step 212 may be where a user of the mobile device 101 dials a number of the communication system 120 (e.g., a 1-800 number) using the communication application 103 and then provides an access code (when prompted) to join a specific conference call. Alternatively, the invitation of step 212 may be to establish a conference session or a regular communication session. For instance, the user may dial in and provide an access code that causes the communication processor 121 to initiate a scheduled conference call by calling members of group defined in the user's calendar. The invitation of step 212 may be a request to establish a conference session with a communication endpoint (e.g., communication endpoint 102A). The invitation of step 212 may also include the data network telephone number/address (may be the same telephone as the cellular telephone number) of the mobile device 101 and/or caller ID of the mobile device 101. Based on the invitation of step 212, the communication session is eventually joined or established in step 214 between the mobile device 101 and one or more of the communication endpoints 102A-102N.

The communication controller 123 determines, in step 216, that the invitation of step 212 is from a data network 110. The communication controller 123 can determine that the invitation of step 212 is from a data network 110 in various ways, such as, based on an administrative input, based on a query made to a provider of the data network (i.e., part of network 110), based on matching telephone numbers, matching caller IDs, based on an identifier of the conferencing application 103 sent in step 212 (could the unique identifier received in step 202), based on a pre-provisioned amount (or an unlimited amount) of data that can be used on the data network, and/or the like. For example, when a query is made to the provider of the data network, if the response indicates that the call is a not a data network call, the process ends after step 216. Otherwise, the received telephone number of step 212 may be matched with known data network telephone numbers/addresses/identifiers to identify the mobile device 101 and possibly a user of the mobile device 101.

In one embodiment, that the communication controller 123 matches, in step 216, the identifier of the communication application 103 that was received in the registration message of step 204 to the identifier of the communication application 103 that was received in in step 212 to determine that the mobile device 101 is using the data network. If it is determined that the mobile device 101 is not using the data network (i.e., using the cellular network), the process ends in step 216.

The process of step 216 is shown after step 214. However, in one embodiment, step 216 may occur before step 214 (e.g., between steps 212 and 214).

The communication controller 123 determines, in step 218, if a quality of the data communication channel 112 has decreased. The quality of the data communication channel 112 can decrease based on various parameters, such as an increase in packet loss, a change in jitter, longer packet delays, an increase in reordered packets, an increase in duplicated packets, higher bit error rates, and/or the like. For example, the quality of the data communication channel 112 may decrease based on a packet loss percentage increasing from 0.1% to 1.1% (e.g., crossing a 1% threshold). The decrease in the quality of the data communication channel 112 may be where the data communication channel 112 fails or causes the communication session on the data communication channel 112 to be dropped.

The quality parameters may be obtained by the communication controller 123 in various ways. For example, the communication controller 123 may get the quality parameters based on Real-Time Control Protocol (RTCP) messages for an audio/video stream of the data communication session that contains the quality parameters. The quality parameters may be based on a time period. The quality parameters may be based on audio, video, virtual reality, and/or multimedia, streams, control channel messages (e.g., SIP messages) and/or the like.

In one embodiment, the communication controller 123 may determine the quality of the data communication channel 112 based on user input. For example, a user may click on a button that indicates that the quality of the communication session is poor (e.g., voice and/or video).

If the invitation of step 212 is from a data network, in step 216, and the quality of the data communication channel 112 has decreased, in step 218, the communication controller 123 sends, in step 220, a push notification message to the push notification service 130. The push notification message of step 220 also includes the unique identifier received in step 204. The push notification message of step 220 may also include additional information, such as, a cellular network dial-able number of the communication controller 123 (e.g., a telephone number to dial to join the conference session that the user originally dialed into), an access code to the conference session (an access code that identifies an individual conference session), a message indicating a reason to switch to a cellular call (e.g., “due to high error rates, you are requested to switch using your cell phone application,” one or more error codes (e.g., packet loss statistics), and/or the like.

In one embodiment, the cellular network dial-able number that is sent in the push notification message of step 220 may change based on the physical location of the mobile device 101. For example, the mobile device 101 may provide location information (e.g., Global Positioning Satellite (GPS) information) to the communication controller 123 via the invitation to join/establish the communication session of step 212. The communication controller 123 may the select a cellular network dial-able number that is local to the provided location of the mobile device 101 (e.g., to avoid long distance charges). For example, the communication controller 123 may provide a 1-800 number if the mobile device 101 is in an area that is not local and a 1-303-XXXX number if the user is in Colorado (where the 303 area code is local).

The push notification service 130, matches, in step 222, the unique identifier in the push notification message of step 220 to the unique identifier sent in step 202. Based on the unique identifier, the push notification service 130 can send, in step 224, the push notification message to the communication application 103 in the mobile device 101 (that includes the additional information). In response to receiving the push notification message of step 224, the mobile device 101 sends, in step 226, the push notification message to the communication application 103.

Based on the information in the push notification message of step 224, the communication application 103 may respond in various ways in step 226. For example, the communication application 103 may make an Application Programming Interface (API) call (or some other method) that causes the cell phone application 102 to automatically dial the communication controller 123 (i.e., using the cellular network dial-able number from the push notification message of step 224) in step 228 using the cellular communication channel 111. In this example, the user would not be prompted and the switch occurs automatically. The switching may be based on a user defined profile or user preferences.

In another embodiment, the communication application 103 may make the API call and the user will be asked by the cell phone application 102 if the user approves the call from the cell phone application 102 of step 228. If approved by the user, the call from the cell phone application 102 is made in step 228 via the cellular communication channel 111.

In another embodiment, the communication application 103 may display a message (e.g., by displaying a message with the cellular network dial-able number and an access code). The message may also say that the communication session on the data communication channel 112 has failed. The user then makes the call using the cellular communication channel 111 manually in step 228.

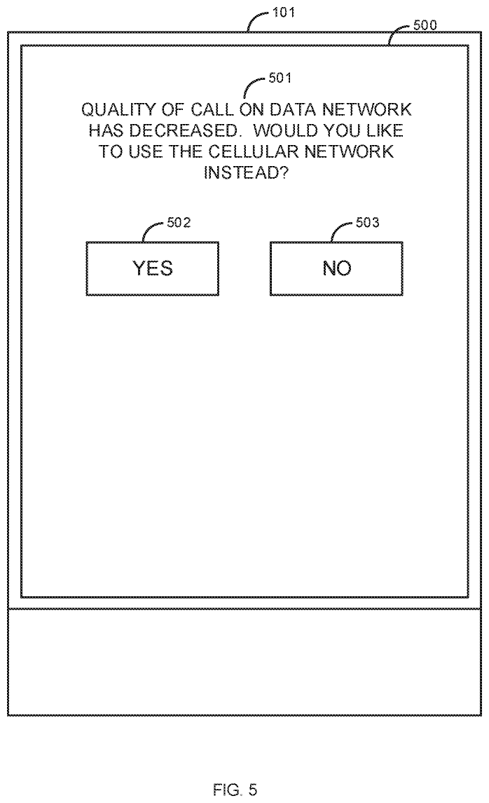

In another embodiment, the user may be displayed a message similar to the one shown in FIG. 5. For instance, the user may click on the yes button 502 in FIG. 5, which causes the communication application 103 to make the API call to the cell phone application 102 to initiate the call from the cell phone application 102 in step 228. In addition, when the user clicks on the yes button, the user may be displayed an additional message (e.g., a window) generated by the operating system (may be operating system dependent). For example, a message box may be displayed asking if the user wants to call telephone number xxx-xxx-xxxx along with yes/no options. Alternatively, the user may be presented a link to the cellular network dial-able number. The user can just click on the link to the cellular network dial-able number. This activates the cell phone application 102, which in turn makes the call of step 228.

In another embodiment (where the data communication channel 112 is still up), a message may be whispered (via a whisper mode) to the user by the communication controller 123, via the data communication channel 112, that the user can make a cellular telephone call, using a provided number, to overcome the quality problems that are in the data communication channel 112. Alternatively, the whisper mode may be a local whisper mode generated by the communication application 103. In this embodiment, the communication controller 123 may send a message to the communication application 103 to play a message locally on the mobile device 101. The user may be asked for approval via a voice command. In both of these embodiments, the user initiates the call manually via the cell phone application 102 in step 228. In both these embodiments, the push notification message of steps 220/224 may not be necessary.

In another embodiment (where the data communication channel 112 is still up), the user, via the whisper mode from the communication controller 123, may be given the option to select a number (e.g., using a keypad on the mobile device 101) to be switched to the cellular communication channel 111. For example, the user may be asked to push “1” (which generates a Dual Tone Multi-Frequency (DTMF)) to be switched to the cellular communication channel 111 or “2” (another DTMF tone) to not be switched. The communication application 103 may be programmed to detect the message, the selection, and/or the Dual Tone Multi-Frequency (DTMF) tones in order to make the call from the cell phone application 102 in step 228. If the user selects “1” the communication application 103 makes the API call to initiate the call from the cell phone application 102 using the cellular network dial-able number in step 228. Alternatively, after selecting “1,” the user may be displayed a message (similar to FIG. 5) or a link to the cellular network dial-able number, which the user can click on to activate the cellphone application 103 to make the call of step 228. In this embodiment, the push notification message of steps 220/224 may not be necessary.

The cellular communication channel 111 is then established in step 230. In one embodiment, the communication application 103 can send, in step 232, DTMF tones for an access code when asked for in the established cellular communication channel of step 230. For example, the communication application 103 may detect that the user is being prompted for an access code and then provides that access code that was provided in the push notification message of step 224. The communication controller 123 sends, in step 234, a message to the communication application 103 to disconnect the communication session on the data communication channel 112.

In one embodiment, the communication application 103 (instead of the communication controller 123) may detect that the quality of the data communication channel 112 has decreased. In this embodiment, the communication controller 123 sends the push notification message (instead of in step 220) when mobile device 101 is added to the communication session. The push notification message sent when the mobile device 101 is added the communication session will include the same information as in the push notification message of step 220. The push notification service 130 will send a similar message as the push notification message of step 224. When the communication application 103 determines that the quality of the data communication channel has decreased, the communication application already has the cellular network dial-able number of the communication controller 123 (e.g., a telephone number to dial to join the conference session that the user originally dialed into), the access code to the conference session, etc. This allows the communication application 103 to initiate the call from the cell phone application 102 in step 228.

While the process of FIG. 2 is described based on a conference call, one of skill in the art would understand that the process of FIG. 2 may also work for regular communication sessions. For example, the process of FIG. 2 will also work for a regular voice/video call between the mobile device 101 and the communication endpoint 102A.

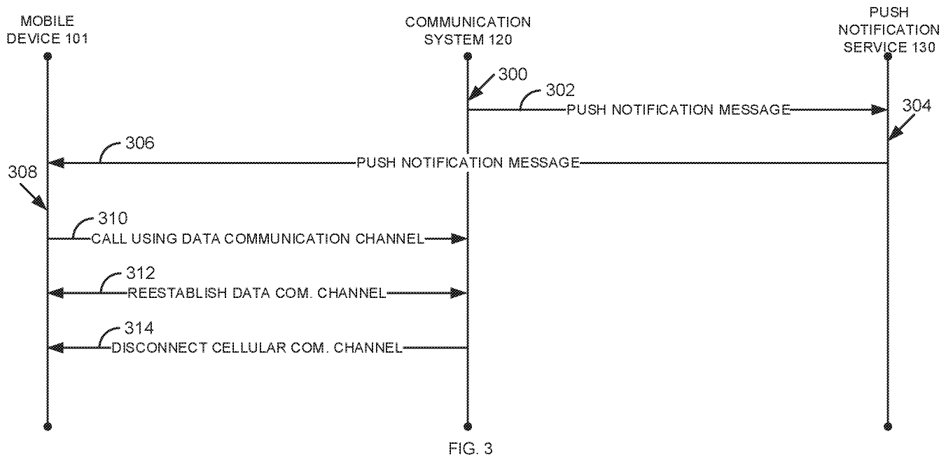

FIG. 3 is a flow diagram of a process for reestablishing a data communication channel 112. The process of FIG. 3 starts after step 234 of FIG. 2. The communication controller 123 determines, in step 300, that the quality of the data network has improved. The communication controller 123 may determine that the quality of the data network has improved in various ways. For example, the communication controller 123 may query the data network, receive a message from the data network, use statistics of other mobile devices 101/communication endpoints 102 that indicate that the data network is now up and/or has an improved quality of service. In response to the data network now being up (if it failed previously) and/or that there is an improved quality of service, the communication controller 123 sends, in step 302, a push notification message. In one embodiment, the sending of the push notification message of step 302 may be administrable. For example, reestablishing the communication session on the data communication channel 112 may be enabled or disabled based on a user administration. The push notification message of step 302 includes the unique identifier (received in step 204). In addition the push notification message of step 302 may include additional information, such as, a telephone number or address that can be used to call the communication controller 123 to reestablish the communication session on the data communication channel 112, an indicator that tells the communication application 103 to reestablish the communication session using the data communication channel 112, and/or the like.

The push notification service 130, matches, in step 304, the unique identifier in the push notification message of step 302 to the unique identifier sent in step 202. Based on the unique identifier, the push notification service 130 can send, in step 306, the push notification message to the communication application 103 in the mobile device 101 (that includes the additional information). In response to receiving the push notification message of step 306, the mobile device 101 passes the information in the push notification message of step 306 to the communication application 103. Receiving the push notification message of step 306 may also launch/activate the communication application 103. The communication application 103 makes a call (e.g., by sending a SIP INVITE message), in step 310 using the data communication channel 112. The communication session using the data communication channel 112 is reestablished in step 312. In response to reestablishing the data communication channel 112 in step 312, the communication controller 123 disconnects the cellular communication channel 111 in step 314.

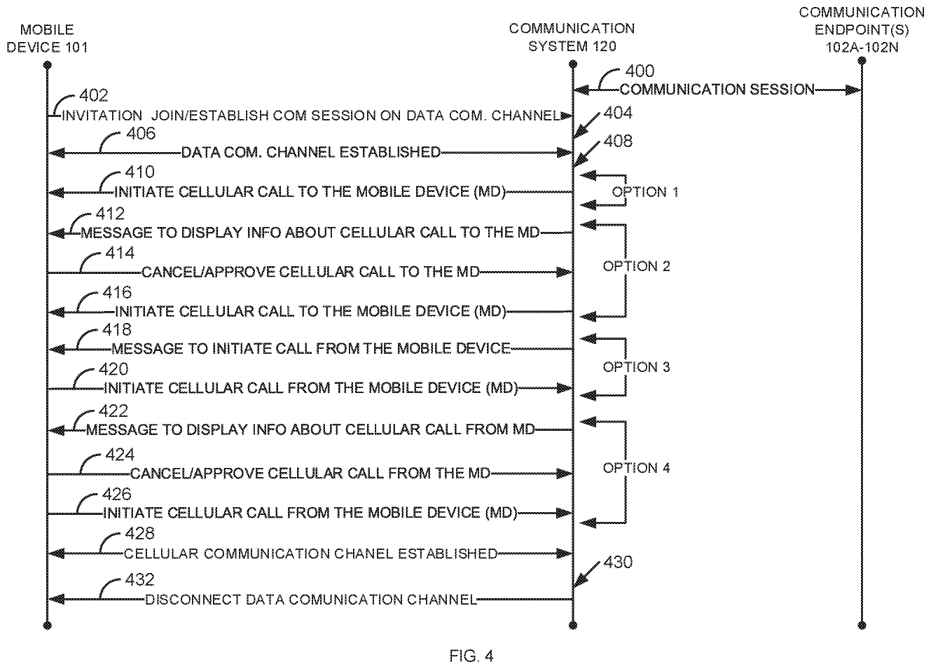

FIG. 4 is a flow diagram of a process for switching a data communication channel 112 to a cellular communication channel 111 based on an observed audio/video quality degradation. The process starts, in step 400 when a communication session is established between the communication system 120 and the communication endpoints 102A-102N (e.g., where callers call into a conference bridge to setup a conference call). Although not shown in FIG. 4, step 400 may occur during steps 402-406 or after steps 402-406.

The communication application 103 sends, in step 402, an invitation (e.g., a SIP INVITE message) to join/establish the communication session on the data communication channel 112. In response to receiving the invitation of step 402, the communication controller 123 determines if the invitation is from a data network in step 404 (e.g., as discussed in step 216). The communication session with the data communication channel 112 is established in step 406. In one embodiment, step 404 may occur after step 406. The communication controller 123 determines, in step 408, if a quality of the data communication channel 112 has decreased (e.g., as discussed above in step 218).

In one embodiment (option 1 in FIG. 4), the communication controller 123 sends, in step 410, an invitation to the mobile device 101 to establish a communication session using the cellular communication channel 111. The invite of step 410 may also be accompanied by a whisper mode (on the call on the data communication channel 112) that states that a call using the cellular communication channel 111 will be incoming and is based on the decreased quality of the data communication channel 112. In one embodiment, the whisper mode may be a local whisper mode generated by the communication application 103. In this embodiment, the communication controller 123 may send a message to the communication application 103 to play a message locally on the mobile device 101. The message may ask the user to approve the message via a voice command. The user of the mobile device 101 then answers the incoming call that uses the cellular communication channel 111.

In one embodiment (option 2 in FIG. 4), the communication controller 123 sends, in step 412, a message to display information about the cellular call to the mobile device 101. For example, the display 500 of FIG. 5 may be shown to the user of the mobile device 101 based on the communication application 103 receiving the message of step 412. The message may give the user of the mobile device 101 an option to cancel or approve the communication controller 123 initiating the cellular call to the mobile device 101 in step 414. For example, the user may click on the yes button 502 or the no button 503 as shown in FIG. 5. This causes the message of step 414 to be sent to the communication controller 123. If the option is to approve the cellular call, the communication controller 123 initiates the call using the cellular communication channel 111, in step 416, to the mobile device 101. In an alternative embodiment, instead of displaying a text message, the communication controller 123 may use a whisper mode to convey the message of step 412. Alternatively, the whisper mode may be a local whisper mode generated by the communication application 103. In this embodiment, the communication controller may send a message to the communication application 103 to play a message locally on the mobile device 101. The user of the mobile device 101 may approve/cancel the cellular call in step 414 based on selecting numbers as discussed previously in FIG. 2 to indicate approval/disapproval of receiving a cellular call.

In one embodiment (option 3 in FIG. 4), the communication controller 123 sends, in step 418, a message that is displayed to the user of the mobile device 101 that tells the user of the mobile device 101 to initiate a call from the mobile device 101. Alternatively, a whisper mode (using the data communication channel 112) may be used to convey the message of step 418. The message/whisper mode may display/speak a number/passcode that the user can take and then manually initiate a cellular call from the mobile device 101 in step 420.

In another embodiment (option 4 of FIG. 4), the communication controller 123 sends, in step 422, a message to display information about the cellular call to the mobile device 101. The message includes a number of the communication controller 123. For example, the display 500 of FIG. 5 may be shown to the user of the mobile device 101 based on the communication application 103 receiving the message of step 422. The message may give the user of the mobile device 101 an option to cancel or approve the communication application 103 making an API call to the cell phone application 102 to initiate a call, in step 426 using the cellular communication channel 111. For example, the user may click on the yes button 502 or the no button 503 as shown in FIG. 5. If the user clicks on the yes button 502, the cellular call is initiated using the cellular communication channel 111 in step 426 by the communication application 103 making an API call. The process of step 422-424 may be accomplished using a whisper mode. For example, the communication controller 123 may whisper the message of step 422 in the data communication channel 112. The communication application 103 detects the user selecting a yes or no option (e.g., by detecting DTMF tones or key presses) and initiates the cellular call of step 426 if the user selects the yes option (e.g., by entering “1” as discussed above).

The cellular communication channel 111 is established in step 428. The communication controller 123, after determining that the cellular communication channel 111 is established in step 428, in step 430, disconnects the data communication channel 112 in step 432.

The process of FIG. 3 may also be also used in a similar manner for FIG. 4. For example, if the quality of the data network improves, the call on the data communication channel 112 may be reestablished and the cellular call may be disconnected.

FIG. 5 is a diagram of a display 500 on a mobile device 101 for switching from a data communication channel 112 to a cellular communication channel 111 based on an observed audio/video quality degradation. FIG. 5 shows a display 500 of the mobile device 101 that is used to switch a data communication channel 112 to a cellular communication channel 111. A message 501 is displayed to the user that states that the quality of the call on the data network has decreased and asks the user if he/she would like to switch the call to the cellular network instead. The user may click on the yes button 502 to switch the call or click on the no button 503 to not switch the call.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that program the microprocessor to:
join, via a data communication channel, a mobile device to a communication session;
determine, during the communication session, that a quality of the data communication channel has decreased;
in response to determining that the quality of the data communication channel has decreased, sending a first push notification message to a push notification service, wherein the first push notification message comprises a cellular network dial-able number that is used by a cellular application in the mobile device to initiate a call to join the communication session via a cellular communication channel that uses a cellular network.

2. The system of claim 1, wherein the communication session is a conference session, wherein the data network is a Voice over Internet Protocol (VoIP) network, and wherein the first push notification message further comprises an access code to the conference session.

3. The system of claim 2, wherein the first push notification message causes the cellular application in the mobile device to automatically initiate the call to join the communication session via the cellular communication channel and to automatically send, using Dual Tone Multi-Frequency (DTMF) tones, the access code via the cellular communication channel.

4. The system of claim 2, where the first push notification message causes the cellular network dial-able number and the access code to be displayed to a user of the mobile device.

5. The system of claim 1, wherein determining that the quality of the data communication channel has decreased is based on a user input.

6. The system of claim 1, wherein determining that the data communication channel uses the data network is based on a pre-provisioned amount of data that can be used on the data network.

7. The system of claim 1, wherein the cellular network dial-able number sent in the first push notification message changes based on a physical location of the mobile device.

8. The system of claim 1, wherein the microprocessor readable and executable instructions further program the microprocessor to:
send a message to the mobile device, via a remote whisper mode in the data communication channel or send a message to play a local message in a local whisper mode, wherein the message in the remote whisper mode and the message in the local whisper mode indicates that the quality of the data communication channel has decreased and asks a user of the mobile device to select an option to approve initiation of the call to join the communication session via the cellular communication channel, wherein selection of the option by the user causes a communication application in the mobile device to detect the selected option, which results in the initiation of the call to join the communication session via the cellular communication channel that uses the cellular network.

9. The system of claim 1, wherein the microprocessor readable and executable instructions further program the microprocessor to:
determine, during the communication session, that a quality of the data network has improved; and
in response to determining that the quality of the data network has improved, sending a second push notification message to the push notification service, wherein the second push notification message causes reestablishment of the data communication channel using the data network and ending the cellular communication channel that uses the cellular network.

10. A method comprising:
joining, by a microprocessor, via a data communication channel, a mobile device to a communication session;
determining, by the microprocessor, that the data communication channel uses a data network of the mobile device;
determine, by the microprocessor and during the communication session, that a quality of the data communication channel has decreased;
in response to determining both that the data communication channel uses the data network of the mobile device and that the quality of the data communication channel has decreased, sending, by the microprocessor, a first push notification message to a push notification service, wherein the first push notification message comprises a cellular network dialable number that is used by a cellular application in the mobile device to initiate a call to join the communication session via a cellular communication channel that uses a cellular network.

11. The method of claim 10, wherein the communication session is a conference session, wherein the data network is a Voice over Internet Protocol (VoIP) network, and wherein the first push notification message further comprises an access code to the conference session.

12. The method of claim 11, wherein the first push notification message causes the cellular application in the mobile device to automatically initiate the call to join the communication session via the cellular communication channel and to automatically send, using Dual Tone Multi-Frequency (DTMF) tones, the access code via the cellular communication channel.

13. The method of claim 11, where the first push notification message causes the cellular network dial-able number and the access code to be displayed to a user of the mobile device.

14. The method of claim 9, wherein the cellular network dial-able number sent in the first push notification message changes based on a physical location of the mobile device.

15. The method of claim 9, further comprising:
determining, by the microprocessor, during the communication session, that a quality of the data network has improved; and
in response to determining that the quality of the data network has improved, sending, by the microprocessor, a second push notification message to the push notification service, wherein the second push notification message causes reestablishment of the data communication channel using the data network and ending the cellular communication channel that uses the cellular network.

16. A system comprising:
a microprocessor; and
a computer readable medium, coupled with the microprocessor and comprising microprocessor readable and executable instructions that program the microprocessor to:
join, via a data communication channel, a mobile device to a communication session;
determine, during the communication session, that a quality of the data communication channel has decreased;
in response to determining that the quality of the data communication channel has decreased, initiating a call to or from the mobile device, via a cellular communication channel.

17. The system of claim 16, wherein the call to or from the mobile device is initiated to the mobile device.

18. The system of claim 16, wherein the microprocessor readable and executable instructions further program the microprocessor to:
determine that the call to or from the mobile device, via the cellular communication channel, is established; and
in response to determining that the call to or from the mobile device via the cellular communication channel is established, automatically disconnect the data communication channel.

19. The system of claim 16, wherein the microprocessor readable and executable instructions further program the microprocessor to:
send a first message to the mobile device that causes the mobile device to display a second message on the mobile device, wherein the second message indicates at least one of:
1) the call to the mobile device is being initiated based on the decrease in quality of the data communication channel;
2) the call to the mobile device will be initiated based on user approval;
3) the call from the mobile device is being initiated; and
4) the call from the mobile device is being initiated based on user approval.

20. A system comprising:
a microprocessor; and
a computer readable medium, coupled with the microprocessor and comprising microprocessor readable and executable instructions that program the microprocessor to:
join, via a data communication channel, a mobile device to a communication session;
in response to joining the mobile device to the communication session, sending a push notification message to a push notification service, wherein the push notification message comprises a cellular network dial-able number that is used by a cellular application in the mobile device to initiate a call to join the communication session via a cellular communication channel that uses a cellular network and wherein the cellular application initiates the call to join the communication session via the cellular communication channel based on determining that the quality of the data communication channel has decreased.
